(19) United States
(12) Patent Application Publication
(10) Pub. No.: US 2026/0293849 A1
(43) Pub. Date: Oct. 1, 2026

(54) PET TREAT DISPENSING TOY WITH INTERNAL SPRING RETENTION MECHANISM

(71) Applicant: Carrie Van Wert, Eden Prairie, MN (US)

(72) Inventor: Carrie Van Wert, Eden Prairie, MN (US)

(21) Appl. No.: 19/578,276

(22) Filed: Mar. 25, 2026

Related U.S. Application Data
(60) Provisional application No. 63/778,101, filed on Mar. 26, 2025.

(51) Int. Cl. A01K 15/02

(52) U.S. Cl. CPC A01K 15/0201; A01K 15/025

(57) ABSTRACT

A pet treat dispensing device includes a body defining an interior cavity and a treat-retaining member disposed within the interior cavity. The treat-retaining member is configured to receive and retain one or more pet treats and to permit release of the treats in response to interaction by a pet. In some embodiments, the treat-retaining member comprises a spring extending within the interior cavity. The body may include one or more openings sized to permit passage of the treats. In some embodiments, the body includes a stem and a cup, and interaction with the device causes movement of the treat-retaining member to progressively displace and release the treats. In other embodiments, the body is enclosed and configured to move to cause release of the treats.

### CROSS REFERENCE TO RELATED APPLICATION

This application claims the benefit of U.S. Provisional Application No. 63/778,101, filed Mar. 26, 2025, which is herein incorporated by reference in its entirety for all purposes.

### TECHNICAL FIELD

The present disclosure relates to pet toys, and more particularly to treat-dispensing pet toys having internal structures configured to retain and release treats in response to interaction with a pet.

### BACKGROUND

Pet owners often seek to provide their pets with toys that promote physical activity and mental stimulation. In particular, treat-dispensing toys may encourage interaction by rewarding a pet with food or treats during play. Conventional treat-dispensing toys rely on simple gravity-fed openings or passive release mechanisms that do not sufficiently engage a pet over extended periods of time. In some cases, treats may be dispensed too easily, reducing the challenge and resulting in diminished interest from the pet.

### SUMMARY

The importance of environmental enrichment for indoor pets has become increasingly recognized in recent years. Veterinarians and animal behaviorists emphasize the need for activities that stimulate both physical and mental faculties. However, many existing products designed for this purpose are too simplistic to maintain long-term engagement. Furthermore, the growing trend of pet owners seeking ways to monitor and improve their pets' health and well being has created a demand for products that can integrate play, exercise, and feeding in a manner that is both beneficial for the pet and convenient for the owner. This has led to an increased interest in modular and customizable solutions that can adapt to different pets' preferences and needs as conventional designs may fail to provide a controlled or progressive release of treats in response to interaction. This can limit the ability of the toy to simulate natural foraging or hunting behaviors, which may be desirable for maintaining engagement. There is therefore a need for improved treat-dispensing toys that retain treats in a more interactive manner and release the treats in response to movement, deformation, or manipulation of the toy by a pet.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a pet treat dispensing device is provided. The device may include a body defining an interior cavity and a spring positioned within the interior cavity. The spring may be configured to receive and retain one or more pet treats.

In embodiments, the body may include a cup or flower-shaped portion disposed at an end of a stem. The spring may be secured to a portion of the stem and extend into the interior cavity of the cup. Interaction with the device may cause movement of the spring such that treats are displaced along the spring and released from the cup.

In embodiments, the body may be a substantially enclosed structure, such as a ball, defining an interior cavity. The spring may be secured within the interior cavity and configured to retain one or more treats. Openings in the body may allow treats to be dispensed when the device is moved or manipulated by a pet.

In embodiments, the interior cavity may be curved, conical, or otherwise shaped to cooperate with the spring to retain treats while permitting release upon interaction with the device.

In embodiments, the spring may be configured to receive toroidal treats that are retained along the spring and progressively released during play.

In embodiments, interaction with the device may include deflection, rotation, or impact caused by a pet, resulting in movement of the spring and corresponding release of treats.

The above summary is not intended to describe each illustrated embodiment or every implementation of the present disclosure. Additional features and advantages will be apparent from the detailed description and the accompanying drawings.

### BRIEF DESCRIPTION OF FIGURES

The disclosure can be understood in consideration of the following detailed description of various embodiments in connection with the accompanying drawings. The drawings are only illustrative of certain embodiments and do not limit the disclosure.

FIG. 1A is a front view of a pet treat toy, according to embodiments.

FIG. 1B is a perspective view of the pet treat toy of FIG. 1A.

FIG. 1C is a top view of the pet treat toy of FIG. 1A.

FIG. 2 is an exploded view of the pet treat toy of FIG. 1A, according to embodiments.

FIG. 3 is a perspective view of a base or petal component of the pet treat toy, according to embodiments.

FIG. 4A is a perspective view of a cup or flower portion of the pet treat toy, according to embodiments.

FIG. 4B is a top view of the cup portion of FIG. 4A.

FIG. 5 is a cross-sectional view of the pet treat toy illustrating internal components, according to embodiments.

FIG. 6A is a perspective view of an alternative stem configuration, according to embodiments.

FIG. 6B is a perspective view of a rotatable leaf assembly secured to a stem, according to embodiments.

FIG. 6C is a perspective view of the leaf assembly of FIG. 6B.

FIG. 7 is a perspective view of a pet treat toy including a leaf assembly and a base, according to embodiments.

FIG. 8A is a front view of a barbed base, according to embodiments.

FIG. 8B is a side view of the barbed base of FIG. 8A.

FIG. 8C is a top view of the barbed based of FIG. 8A.

FIG. 9A is a top view of a ball-shaped pet treat toy, according to embodiments.

FIG. 9B is a side view of the pet treat toy of FIG. 9A.

FIG. 9C is an exploded side view of the ball-shaped pet treat toy of FIG. 9A.

FIG. 9D is a perspective view of an interior portion of the ball-shaped pet treat toy of FIG. 9A.

FIG. 9E is a top view of the interior portion of the ball-shaped pet treat toy of FIG. 9D.

FIG. 9F is a side view of a spring used with the ball-shaped pet treat toy, according to embodiments.

FIG. 9G is a perspective view of the spring of FIG. 9F.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The pet treat toy embodiments disclosed herein may provide a versatile and engaging activity device for pets, particularly cats, by retaining one or more treats in a manner that encourages repeated interaction before release. In embodiments, the toys disclosed herein may be configured to simulate or promote natural hunting, foraging, batting, swatting, chasing, and retrieval behaviors. In some embodiments, the toy may be configured such that a treat is not immediately released on first contact, but rather is progressively displaced and eventually released after repeated interaction. This progressive release may maintain engagement and increase the challenge presented to the pet relative to passive gravity-fed treat devices.

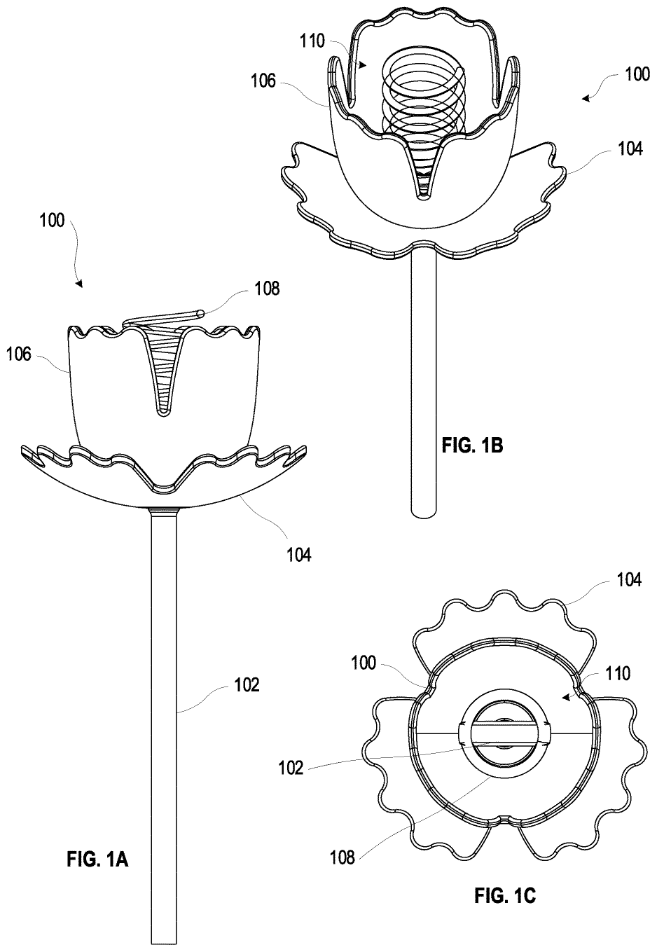

Referring to FIGS. 1A-1C, a pet treat toy 100 is shown, according to embodiments. The toy 100 may include a stem 102, a petal or base portion 104, and a cup or flower portion 106. The flower portion 106 may define an interior cavity 110. A treat-retaining member, such as spring 108, may be disposed within the interior cavity 110. In embodiments, the flower portion 106 may resemble a tulip or other flower. In embodiments, the petal or base portion 104 may provide an ornamental appearance while also providing stability to the toy 100. In embodiments, one or more treats may be loaded within the interior cavity 110. In embodiments, one or more treats may be loaded on the spring 108. In embodiments, the treats may comprise toroidal treats receivable on the spring 108. In embodiments, the treats may comprise kibble, ring-shaped treats, cylindrical treats, spherical treats, irregular treats, or combinations thereof. Examples of such treats are shown and described in U.S. patent application Ser. No. 18/803,124 and 29/912,189, the disclosures of which are incorporated herein in their entireties for all purposes, may be used in combination with any of the structures described in the present application.

In embodiments, the flower portion 106 may define a generally curved, arcuate, tapered, or conical interior cavity 110. In embodiments, the geometry of the interior cavity 110 may cooperate with the spring 108 to retain treats and to influence how treats move and are released during play. In embodiments, the interior cavity 110 may taper toward an upper opening of the flower portion 106. In embodiments, the opening of the flower portion 106 may be sized to permit passage of treats while restricting direct access by a pet to the spring 108 or to treats disposed deeper in the interior cavity 110. In embodiments, the flower portion 106 may have an overall width of about 1 inch to about 4 inches. In embodiments, the interior cavity 110 may have a depth of about 1 inch to about 3 inches. In embodiments, the opening of the flower portion 106 may have a diameter of about 0.5 inch to about 2.5 inches. In embodiments, these dimensions may be selected such that treats can be dispensed while reducing the likelihood that a paw of a pet becomes lodged in the opening.

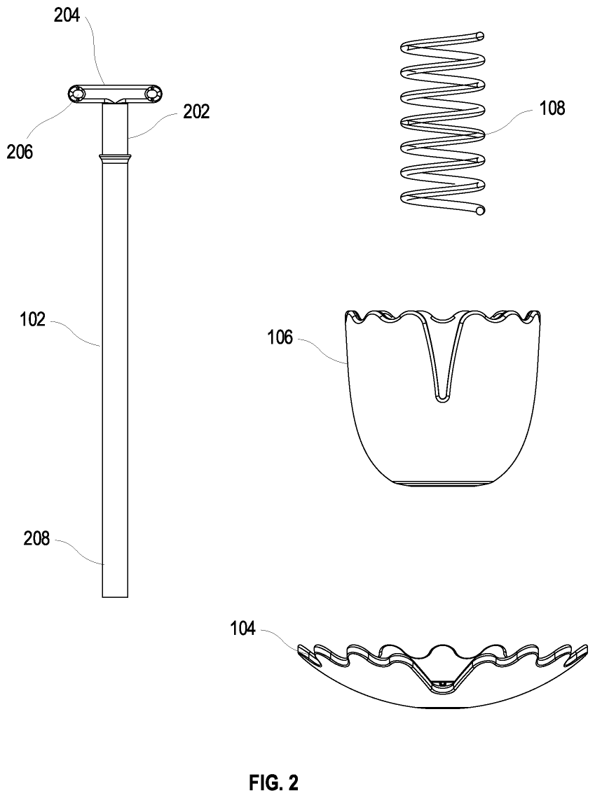

Referring to FIG. 2, an exploded view of the pet treat toy 100 is shown. In embodiments, the stem 102 may have a head portion 202 and a base portion 208. In embodiments, the head portion 202 may define a support structure for the spring 108. In embodiments, the head portion 202 may include a cross member 204 having one or more openings 206 for receiving, securing, or threading the spring 108. In embodiments, the spring 108 may extend through one or more openings 206. In embodiments, the spring 108 may be friction fit, press fit, adhesively secured, molded in place, heat staked, mechanically retained, or otherwise secured relative to the support structure defined by head portion 202 and cross member 204. In embodiments, the stem 102 may have a length of about 1 inch to about 8 inches. In embodiments, the stem 102 may have a width or diameter of about 0.1 inch to about 1 inch.

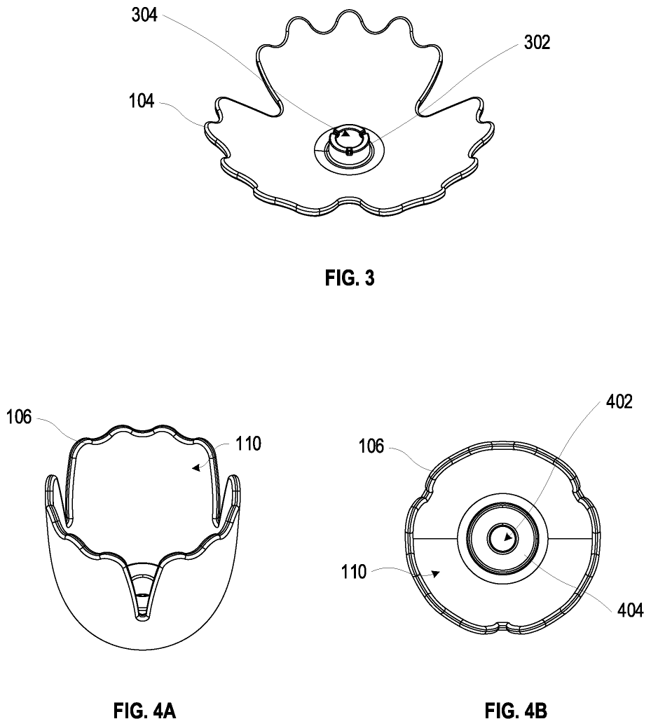

Referring to FIG. 3, the petal or base portion 104 is shown. In embodiments, the petal portion 104 may include an upward projection 302 that interfaces with the flower portion 106. In embodiments, the upward projection 302 may define a central opening 304 configured to permit passage of the stem 102. In embodiments, the petal portion 104 may stabilize the toy 100 and may distribute forces when the toy is struck or deflected by a pet. In embodiments, the petal portion 104 may be flexible, semi-rigid, or rigid. In embodiments, the petal portion 104 may be shaped as petals, leaves, organic forms, or other ornamental structures.

Referring to FIGS. 4A and 4B, the flower portion 106 is shown. In embodiments, the interior cavity 110 of the flower portion 106 may receive the spring 108. In embodiments, an opening 402 at a bottom portion 404 of the flower portion 106 may permit passage of the stem 102 while preventing passage of the support structure, such as cross member 204. In this manner, the flower portion 106 may be retained on the stem 102 while capturing the support structure and spring 108 within the interior cavity 110. In embodiments, the bottom opening 402 may be sized smaller than the overall span of cross member 204. In embodiments, the bottom opening 402 may have a diameter of about 0.1 inch to about 0.75 inch.

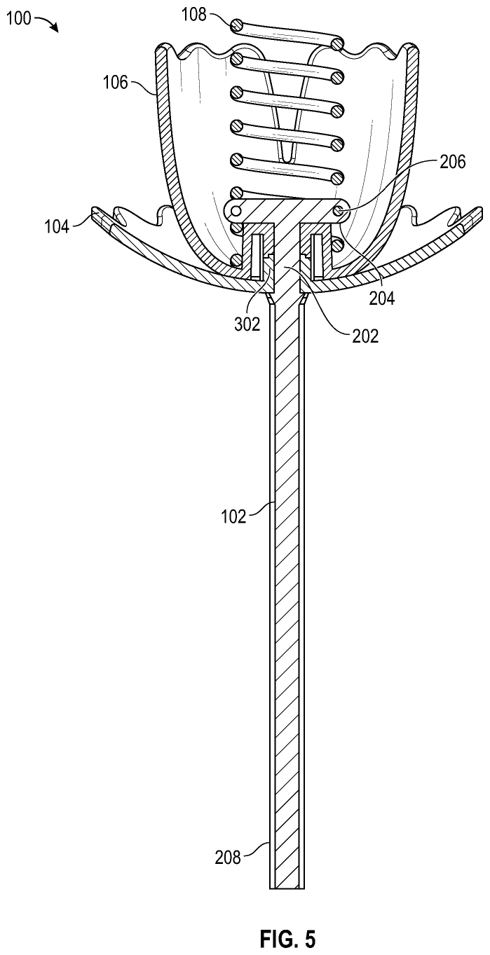

Referring to FIG. 5, a cross-sectional view of the assembled toy 100 is shown. As depicted, the stem 102 extends through petal portion 104 and into flower portion 106. Support structure 202, including cross member 204 and openings 206, is disposed within interior cavity 110. Spring 108 extends upwardly from the support structure 202 toward an opening of the flower portion 106. In embodiments, the spring 108 may have a diameter of about 0.5 inch to about 1.5 inches. In embodiments, the spring 108 may have a length of about 1 inch to about 3 inches. In embodiments, the spring 108 may have a pitch or spacing between adjacent coils of about 2 mm to about 12 mm, and in some embodiments about 8 mm to about 9 mm. In embodiments, the spring 108 may have about 2 to about 10 turns. In embodiments, the spring 108 may be selected such that one or more treats are retained under static conditions while still being movable along the spring in response to dynamic forces produced during play.

In operation, interaction with the toy 100, such as batting, swatting, biting, or pushing by a pet, may cause deflection of the stem 102 and corresponding movement of the spring 108. In embodiments, this movement may progressively displace one or more treats along the spring 108 and eventually release the treats from the flower portion 106. In embodiments, the spring 108 may constrain the treats such that the treats are not freely dispensed without first moving along the spring 108. In embodiments, multiple interactions may be required before a treat is released. In embodiments, a first treat may be released while one or more additional treats remain retained on or by the spring 108. Continued interaction may result in successive release of additional treats. In embodiments, the release pattern may be somewhat unpredictable such that similar interactions do not always produce the same release result. This may increase engagement by the pet.

In embodiments, the treats may be threaded on the spring 108. In embodiments, the treats may alternatively be positioned within the interior cavity 110 without being threaded on the spring 108. In such embodiments, the spring 108 may act as a partial barrier, restraint, or interference structure that impedes movement of the treats until sufficient interaction causes the treats to move past or around the spring 108 and exit the flower portion 106. In embodiments, relatively larger treats may be partially restrained by the spring 108 while smaller treats may be threaded onto the spring 108.

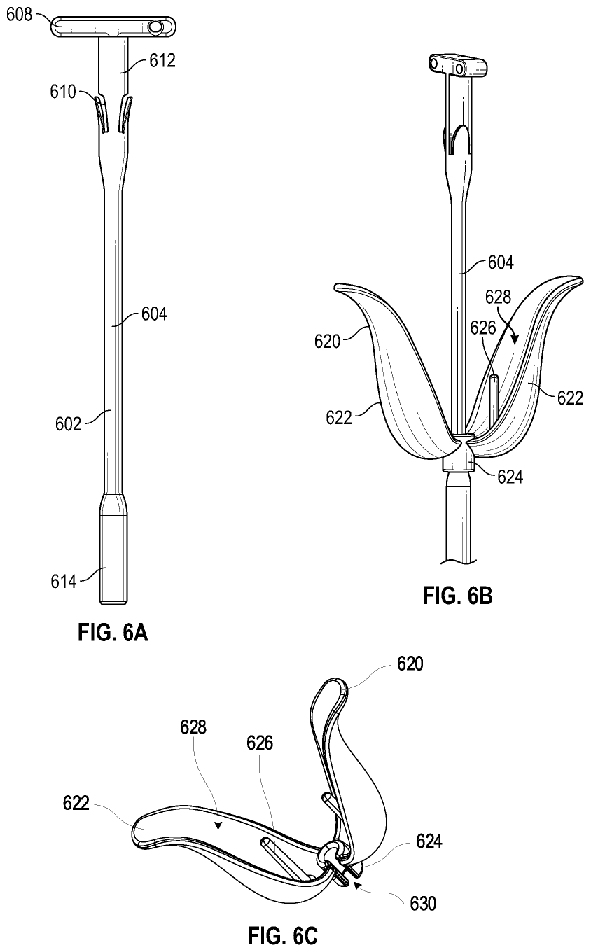

Referring to FIG. 6A, an alternative stem 602 is shown, according to embodiments. In embodiments, stem 602 may include a head portion 608, a base portion 614, and a narrowed or tapered middle portion 604. In embodiments, a hinge region 606 may permit flexing of the head portion 608 relative to the base portion 614. In embodiments, the hinge region 606 may be formed by one or more slits 610 in the stem 602. In embodiments, the tapered middle portion 604 may provide a reduced cross-section that enhances bending or flicking behavior during play. In embodiments, the hinge region 606 may store and release energy as the stem 602 is deflected and rebounds, thereby increasing motion imparted to attached structures and increasing the likelihood that a retained treat is displaced or flung from the toy. In embodiments, the stem 602 may be formed from a polymer or elastomer having sufficient flexibility to permit repeated cycling without fracture.

Referring to FIGS. 6B and 6C, a leaf toy 620 is shown. In embodiments, leaf toy 620 may include one or more leaves 622 joined at a central portion 624. In embodiments, the central portion 624 may define a slit 630 permitting the leaf toy 620 to be secured about the stem 602. In embodiments, the central portion 624 may snap around the tapered middle portion 604 such that the leaf toy 620 is retained in position and does not slide downward beyond the tapered middle portion 604. In embodiments, each leaf 622 may have a generally curved, arcuate, or cup-like shape defining an interior cavity 628 configured to receive one or more treats. In embodiments, one or more protrusions 626 may extend upwardly from within the interior cavity 628 and may receive or partially retain treats. In embodiments, the leaf toy 620 may be configured to rotate or spin about the stem 602 when struck by a pet. When the leaf toy 620 rotates sufficiently, one or more treats may be flung from interior cavities 628, allowing the pet to retrieve them. In embodiments, the leaf toy 620 may provide an alternative treat-retaining structure that still operates according to the general principle of retaining treats within a cavity and releasing the treats in response to pet interaction.

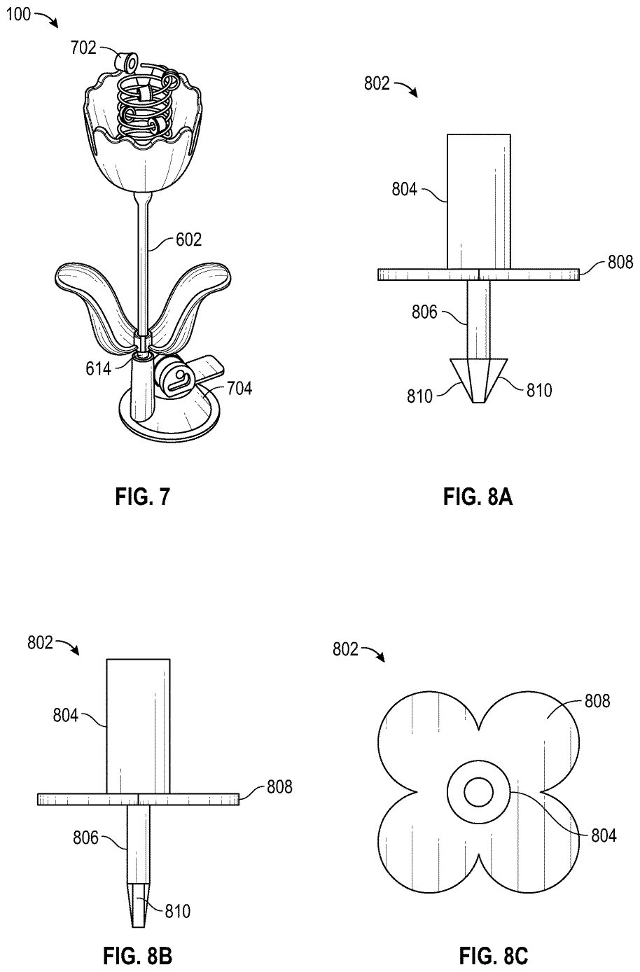

Referring to FIG. 7, an embodiment of toy 100 is shown including stem 602, leaf toy 620, one or more treats 702, and a suction cup base 704. In embodiments, the base portion 614 of the stem 602 may be inserted into or otherwise secured relative to suction cup base 704. In embodiments, suction cup base 704 may permit the toy to be removably secured to a floor, tabletop, wall, or other surface. In embodiments, securing the toy to a surface may enhance the pet's ability to swat, bend, flick, or otherwise manipulate the toy while keeping the toy in a target play area.

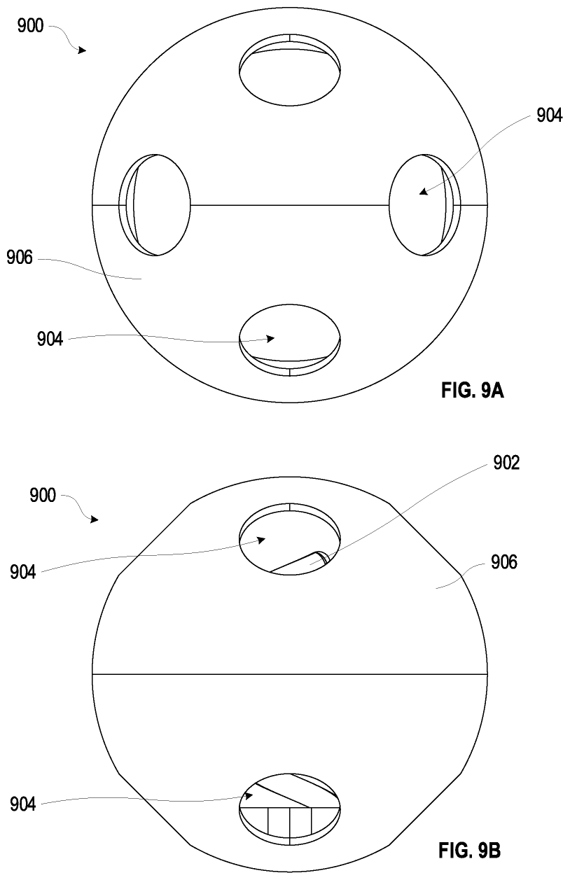

Referring to FIGS. 8A-8C, a barbed base 802 is shown, according to embodiments. In embodiments, barbed base 802 may include an upward protrusion 804, a barbed end 806, and a platform 808 disposed therebetween. In embodiments, the barbed end 806 may include one or more barbs 810 extending outwardly. In embodiments, the one or more barbs 810 may extend in a common plane. In embodiments, barbed base 802 may be configured to pierce and secure into a substrate such as a cat scratcher assembly, corrugated pad, cardboard structure, carpet-like member, or other support. In embodiments, the barbed end 806 may be wider in one direction than another, such that the base 802 may be inserted and then rotated, such as with a quarter turn, to secure the base in place. In embodiments, the platform 808 may be shaped as a petal, leaf, or other nature-inspired form. In embodiments, the barbed base 802 may have an overall length of about 0.5 inch to about 3 inches.

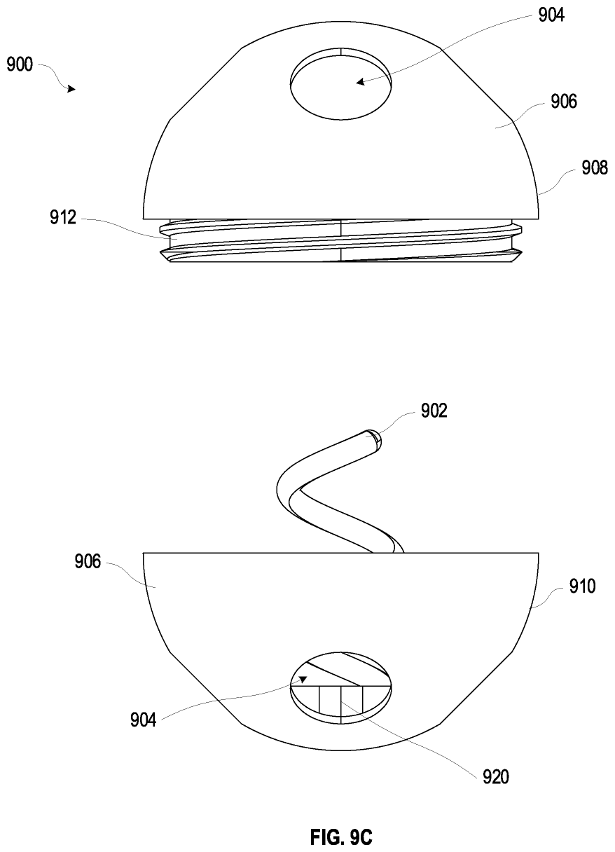

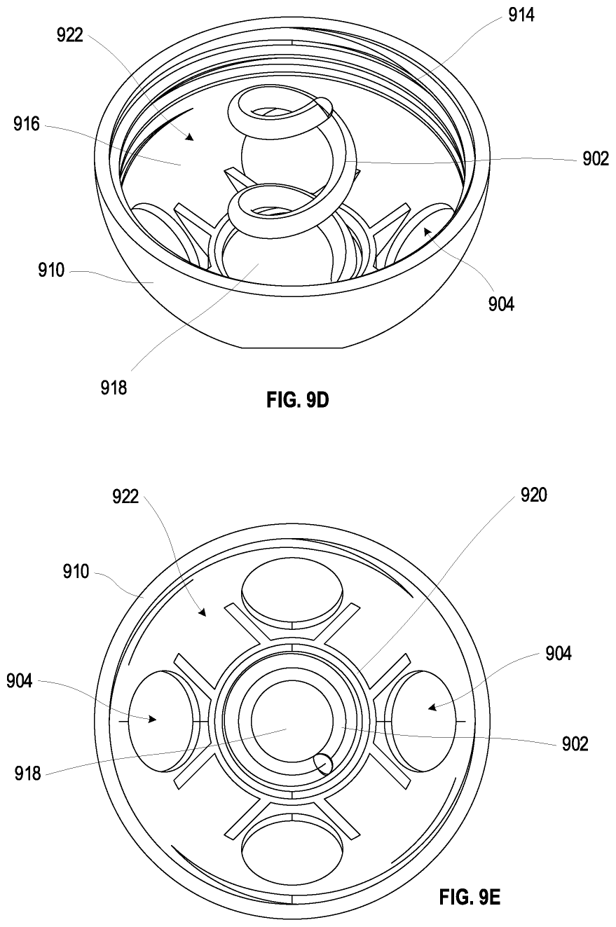

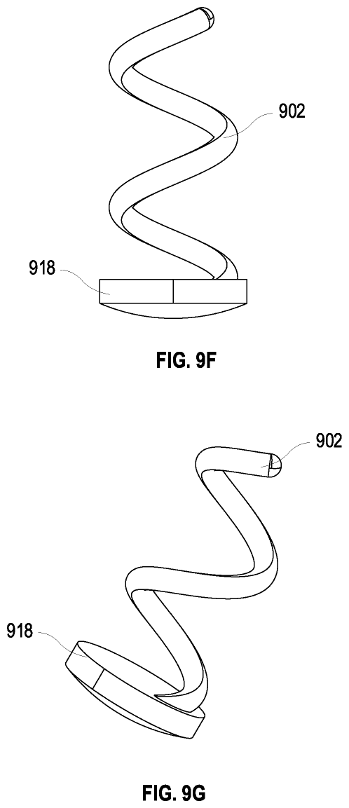

Referring to FIGS. 9A-9G, an alternative embodiment of a pet treat toy 900 is shown. In embodiments, toy 900 may be ball-shaped and may share characteristics with toy 100 in that both include an interior cavity and a spring configured to retain and release treats in response to pet interaction. Referring specifically to FIGS. 9A and 9B, toy 900 may include a body 906 having one or more openings 904. In embodiments, openings 904 may be sized to permit passage of treats while reducing the likelihood that a paw of a pet becomes trapped in the openings. In embodiments, openings 904 may have a width or diameter of about 5 mm to about 25 mm, and in some embodiments about 14 mm. In embodiments, body 906 may have an overall diameter of about 1 inch to about 4 inches, and in some embodiments about 2 inches.

Referring to FIG. 9C, the toy 900 may be separable into cooperating portions 908 and 910. In embodiments, a projection 912 on one portion may engage corresponding threads 914 on the other portion. In embodiments, the threaded arrangement may be reversed. In embodiments, portions 908 and 910 may alternatively be joined by a friction fit, snap fit, bayonet connection, adhesive connection, flexible latch, or other closure. In embodiments, some or all of body 906 may be flexible such that one portion may be squeezed or deformed during assembly.

Referring to FIGS. 9D and 9E, an interior 922 of portion 910 is shown. In embodiments, a support structure 920 may extend from an interior surface 916 of the body 906. In embodiments, the support structure 920 may be a projection, post, peg, wall feature, molded boss, or other structure configured to secure a spring. In embodiments, support structure 920 may receive or retain a base portion 918 of spring 902.

Referring to FIGS. 9F and 9G, spring 902 is shown. In embodiments, spring 902 may include base portion 918 configured to attach to support structure 920. In embodiments, spring 902 may be formed from metal wire, coated wire, plastic, polymer, elastomeric material, or combinations thereof. In embodiments, spring 902 may have a diameter of about 0.5 inch to about 1.5 inches and a length of about 1 inch to about 3 inches. In embodiments, the spring 902 may retain one or more treats on or by the spring. In embodiments, the treats may be threaded on spring 902. In embodiments, the treats may instead be disposed within the interior of body 906 and be partially restrained by spring 902 during movement of the toy 900.

In operation, rolling, pushing, shaking, batting, or otherwise moving toy 900 may cause movement of the body 906 and corresponding movement of spring 902. Such movement may progressively displace treats relative to spring 902 and may result in release of one or more treats through openings 904. In embodiments, the toy 900 may be configured to release treats regardless of orientation, such as while rolling, tumbling, or inverting. In embodiments, a first treat may be released while one or more other treats remain retained for later release.

In embodiments, the dimensions of openings 904, spring 902, spring pitch, and interior cavity geometry may be selected based on treat size and shape. In embodiments, the dimensions may be selected such that treats are retained under ordinary handling conditions but are released in response to dynamic interaction during play. In embodiments, larger openings may permit faster dispensing, while smaller openings may increase difficulty. In embodiments, larger spring pitch may permit easier translation of treats, while smaller spring pitch may increase retention. In embodiments, overlapping dimensional ranges may be used for different treat sizes, pet sizes, or difficulty levels. In embodiments, the release pattern may be somewhat unpredictable such that similar interactions do not always produce the same release result. This may increase engagement by the pet.

In embodiments, components of toys 100 and 900 may be formed from plastics, elastomers, rubbers, thermoplastic polyurethane (TPU), silicone, coated metal wire, polymer-coated wire, or combinations thereof. In embodiments, materials may be selected to provide durability, flexibility, resilience, and resistance to chewing or repeated impacts. In embodiments, softer materials may be used at outer surfaces to enhance safety and pet contact, while more rigid materials may be used internally for support and retention.

It should be understood that the embodiments described herein, including the stem-based embodiments and the enclosed body embodiments, share a common functional principle in which a treat-retaining member is disposed within an interior cavity and configured to retain and release treats in response to interaction. Variations in external form, including open, partially enclosed, or fully enclosed structures, are not intended to define distinct inventions, but rather represent different implementations of the same underlying concept.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A pet treat dispensing device, comprising:
a body defining an interior cavity;
a support structure disposed within the interior cavity;
a treat-retaining member secured relative to the support structure and extending within the interior cavity;
wherein the treat-retaining member is configured to receive and retain one or more pet treats; and
wherein interaction of a pet with the device causes movement of at least one of the body or the treat-retaining member such that the one or more pet treats are progressively displaced relative to the treat-retaining member and released from the body.

2. The device of claim 1, wherein the treat-retaining member comprises a spring.

3. The device of claim 1, wherein the support structure is the distal end of a stem.

4. The device of claim 1, wherein the treat-retaining member is configured to resist release of the one or more pet treats under static conditions and to permit release only upon repeated interaction by the pet.

5. The device of claim 1, wherein the body comprises a ball including a first portion releasably engaged with a second portion.

6. A pet treat dispensing device, comprising:
a body defining an interior cavity;
a support structure disposed within the body;
a spring secured to the support structure and extending within the interior cavity;
wherein the spring is configured to receive and retain the one or more pet treats thereon; and
wherein interaction of a pet with the device causes movement of at least a portion of the device and corresponding movement of the spring such that the one or more pet treats are progressively displaced along the spring and released from the interior cavity.

7. The device of claim 6, wherein the body defines one or more openings sized to permit passage of one or more pet treats, and the body further comprises first and second portions removably secured together.

8. The device of claim 6, wherein the interior cavity is defined by a curved inner surface.

9. The device of claim 6, wherein the support structure comprises a projection extending from an interior surface of the body.

10. The device of claim 6, further comprising a stem extending from the body, wherein the support structure comprises a head portion of the stem.

11. A pet treat dispensing system, comprising:
a stem having a proximal base and a distal support structure;
a cup disposed at a distal end of the stem and defining an interior cavity, the support structure being disposed within the interior cavity;
a spring secured to the support structure and extending within the interior cavity;
wherein the spring is configured to receive and retain one or more pet treats thereon; and
wherein interaction of a pet with the device causes deflection of the stem and corresponding movement of the spring such that the one or more pet treats are progressively displaced along the spring and released from the cup.

12. The system of claim 11, wherein the support structure comprises a cross member having one or more apertures through which the spring extends.

13. The system of claim 11, wherein the cup includes a bottom opening sized to permit passage of the stem while preventing passage of the support structure.

14. The system of claim 11, further comprising the one or more pet treats, wherein the one or more pet treats comprise toroidal treats receivable on the spring.

15. The system of claim 11, wherein the interior cavity is defined by a curved sidewall.

16. The system of claim 11, wherein an opening of the cup is sized to restrict direct access by a pet to the spring.

17. The system of claim 11, wherein the spring is configured such that multiple interactions are required before release of at least one treat.

18. The system of claim 11, wherein the base comprises a suction cup.

19. The system of claim 11, wherein the base comprises a barbed element configured to engage a substrate.

20. The system of claim 11, wherein the spring extends from the support structure toward an opening of the cup.
